(19) United States
(12) Patent Application Publication
(10) Pub. No.: US 2025/0253466 A1
(43) Pub. Date: Aug. 7, 2025

(54) BATTERY SYSTEM

(71) Applicants: Hyundai Motor Company, Seoul (KR); Kia Corporation, Seoul (KR)

(72) Inventors: Keun Jin KIM, Seongnam-Si (KR); Hyuck Jun JANG, Hwaseong-Si (KR); Doo Hee HAN, Seoul (KR); Min Kyun KIM, Seoul (KR)

(73) Assignees: Hyundai Motor Company, Seoul (KR); Kia Corporation, Seoul (KR)

(21) Appl. No.: 18/797,210

(22) Filed: Aug. 7, 2024

(30) Foreign Application Priority Data
Feb. 5, 2024 (KR) 10-2024-0017587

(51) Int. Cl. H01M 50/242; H01M 50/209; H01M 50/249; H01M 50/262; H01M 50/291

(52) U.S. Cl. CPC H01M 50/242; H01M 50/209; H01M 50/249; H01M 50/262; H01M 50/291; H01M 2220/20

(57) ABSTRACT

A battery system configured for enhancing design freedom of a battery coupling structure through easy variation of a position of a fixing element configured to fix a battery cell is disclosed. The battery system includes battery cells mounted in an accommodation space formed in a battery casing for a battery so that the battery cells overlap one another in a row direction and a column direction, a dummy cell having a predetermined stiffness or more than the predetermined stiffness and mounted in the accommodation space to substitute for a battery cell disposed at a position required for fixing to the battery casing among the battery cells, and a fixing element fixed to the battery casing while extending through the dummy cell.

### CROSS-REFERENCE TO RELATED APPLICATION

The present application claims priority to Korean Patent Application No. 10-2024-0017587 filed on Feb. 5, 2024, the entire contents of which is incorporated herein for all purposes by this reference.

### BACKGROUND OF THE PRESENT DISCLOSURE

### Field of the Present Disclosure

The present disclosure relates to a battery system configured to easily vary a position of a fixing element to fix a battery cell, enhancing design freedom of a battery coupling structure.

### Description of Related Art

In the case of a battery pack, several lateral members and several longitudinal members are disposed to divide a space in which a battery module is mounted.

In the instant case, accordingly, through mountings extend from an upper case to a lower case of a battery at many positions along the lateral members and the longitudinal members as well as outside members and are fastened to the upper case and the lower case.

As the battery is mounted to a vehicle through a plurality of through mountings, as mentioned above, it may be possible to secure collision/durability/noise, vibration and harshness (NVH) stiffness between the vehicle and the battery.

Meanwhile, electric vehicle battery systems are being developed toward maximally increasing an integration of a battery in a limited battery space to increase an all-electric range (AER) of an electric vehicle.

For example, a scheme in which members and through mountings disposed within a battery space are removed to enable battery cells to fill the entirety of the battery space, increasing an integration of a battery, may be proposed.

In the instant case, however, there may be a problem in that stiffness of the battery itself should be reinforced, and accordingly, noise, vibration, and harshness (NVH) performance of the vehicle may be degraded. To the present end, a structure for minimizing internal members of the battery, through mountings, etc. is proposed.

However, once positions of the internal members and through mountings are determined in a battery development stage, it is difficult to vary the positions so far as an internal structure of the battery is not varied.

For the present reason, in vehicles using the same battery, a coupling structure between the battery and each vehicle should be designed to suit the battery. As a result, there is a problem of degradation in design freedom.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a battery system configured to easily vary a position of a fixing element configured to fix a battery cell, enhancing design freedom of a battery coupling structure.

In accordance with an aspect of the present disclosure, the above and other objects may be accomplished by the provision of a battery system including battery cells mounted in an accommodation space formed in a battery casing for a battery so that the battery cells overlap one another in a row direction and a column direction, a dummy cell having a predetermined stiffness or more than the predetermined stiffness and mounted in the accommodation space to substitute for a battery cell disposed at a position required for fixing to the battery casing among the battery cells, and a fixing element fixed to the battery casing while extending through the dummy cell.

The fixing element may extend through the dummy cell in an upward-downward direction, and may be fastened to upper and lower plates of the battery casing.

Fastening holes may be formed at the upper plate and the lower plate, corresponding to upper and lower end portions of the fixing element, respectively, and the fixing element may be fastened to the fastening holes.

The battery cells and the dummy cell may be fixed to other battery cells and another dummy cell overlapping therewith.

The dummy cell and the battery cells disposed in the same row or column as the dummy cell may be surface-bonded to one another at peripheral surfaces thereof by a bonding member.

The battery cells and the dummy cell may be continuously fixed to one another in the row direction and the column direction, to be connected together in a form of a module.

The battery cells and the dummy cell may be fixed to a bottom surface of the battery.

Lower surfaces of the battery cells and the dummy cell may be surface-bonded to an upper surface of a lower plate of the battery casing surface-contacting with the lower surfaces by a bonding member.

The accommodation space may be formed through interconnection of members disposed at front, rear, left and right sides of the battery. Cells facing the interconnected front, rear left and right members among the battery cells and the dummy cell may be fixed to the interconnected front, rear left and right members.

Inner surfaces of members respectively connected to front, rear, left and right sides of the battery may be surface-bonded to peripheral surfaces of the battery cells and the dummy cell facing the internal surfaces by a bonding member.

The dummy cell is mounted in plural in the battery. A stay may be connected among the plurality of dummy cells to enhance coupling stiffness among the plurality of dummy cells.

The dummy cells may be mounted under a condition that at least one battery cell is disposed therebetween, and the stay may be connected between the dummy cells while extending across the at least one battery cell between the dummy cells.

The stay may be connected to the dummy cells under the dummy cells.

The stay may be formed to have an “I” shape, and may be connected among the plurality of dummy cells mounted in the column direction.

The stay may be formed to have an “I” shape, and may be connected among the plurality of dummy cells mounted in the row direction.

The stay may be formed to have an “X” shape, and may be connected among the plurality of dummy cells mounted in the column direction and the row direction.

In accordance with the present disclosure, the following effects are provided through the above-described configurations. That is, a battery mounting structure is realized by mounting a rigid dummy cell at a desired position in place of a battery cell disposed at the position, and fastening the dummy cell to a battery casing. Accordingly, it may be possible to enhance freedom of design of the battery by designing a coupling structure between the battery and a vehicle, in which the battery is mounted, in accordance with a structure of the vehicle.

Furthermore, it may be possible to increase an all-electric range through enhancement in battery integration degree. Furthermore, an enhancement in mounting coupling force may be achieved by the rigid dummy cell. Accordingly, collision/durability/noise, vibration and harshness (NVH) performance may be maintained and enhanced.

Effects attainable in an exemplary embodiment of the present disclosure are not limited to the above-described effects, and other effects of the present disclosure not yet described will be more clearly understood by those skilled in the art from the following detailed description.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view showing a shape of battery cells and a dummy cell mounted in an accommodation space of a battery in accordance with an exemplary embodiment of the present disclosure;

FIG. 2 is a sectional view explaining an internal structure of the dummy cell according to an exemplary embodiment of the present disclosure;

FIG. 3 and FIG. 4 are views showing external shapes of upper and lower end portions of the dummy cell according to the exemplary embodiment of the present disclosure;

FIG. 5, FIG. 6, FIG. 7 and FIG. 8 are views explaining a configuration in which the battery cells and the dummy cell are fixed by a bonding member in accordance with an exemplary embodiment of the present disclosure;

FIG. 9 is a view showing a stay having an “I” shape in accordance with an exemplary embodiment of the present disclosure;

FIG. 10 is a view showing a stay having an “X” shape in accordance with another exemplary embodiment of the present disclosure; and

FIG. 11 is a view showing a rectangular battery cell applied to the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings, and the same or similar elements are designated by the same reference numerals regardless of the numerals in the drawings and redundant description thereof will be omitted.

Although “module” or “unit” is suffixed to constituent elements described in the following description, this is intended only for ease of description of the specification. The suffixes themselves have no meaning or function to distinguish the constituent element using the suffix from the constituent element using no suffix.

In the following description of the exemplary embodiments of the present disclosure, a detailed description of known functions and configurations incorporated herein will be omitted when it may obscure the subject matter of the exemplary embodiments of the present disclosure. Furthermore, the exemplary embodiments of the present disclosure will be more clearly understood from the accompanying drawings and should not be limited by the accompanying drawings, and it is to be appreciated that all changes, equivalents, and substitutes that do not depart from the spirit and technical scope of the present disclosure are encompassed in the present disclosure.

It will be understood that, although the terms “first”, “second”, etc. may be used herein to describe various elements, these elements should not be limited by these terms. These terms are only used to distinguish one element from another.

In the case where an element is “connected” or “linked” to another element, it should be understood that the element may be directly connected or linked to the other element, or another element may be present therebetween. Conversely, in the case where an element is “directly connected” or “directly linked” to another element, it should be understood that no other element is present therebetween.

Unless clearly used otherwise, singular expressions include a plural meaning.

In the present specification, the term “comprising”, “including”, or the like, is intended to express the existence of the characteristic, the numeral, the step, the operation, the element, the portion, or the combination thereof, and does not exclude another characteristic, numeral, step, operation, element, portion, or any combination thereof, or any addition thereto.

Hereinafter, various exemplary embodiments of the present disclosure will be described in detail with reference to the accompanying drawings.

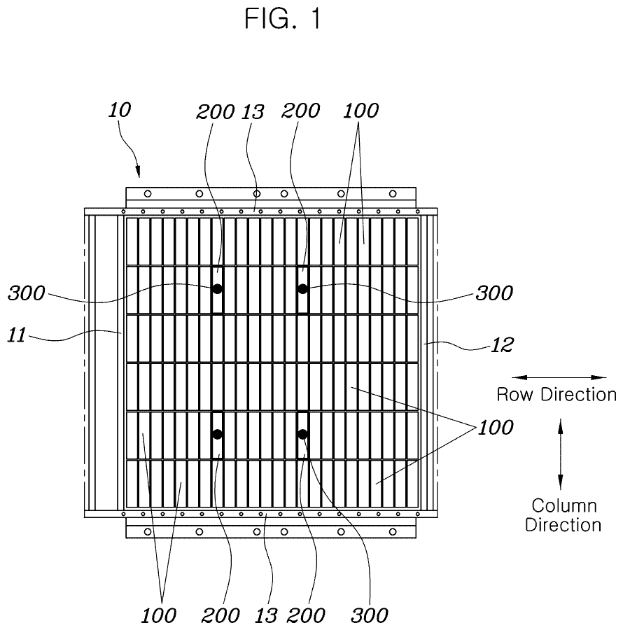

Referring to FIG. 1, a battery system according to an exemplary embodiment of the present disclosure is shown. The battery system includes battery cells 100 mounted in an accommodation space formed in a battery casing 400 so that the battery cells 100 overlap one another in a row direction and a column direction, a dummy cell 200 configured to have a predetermined stiffness or more and mounted in the accommodation space to substitute for a battery cell 100 disposed at a position required for fixing to the battery casing 400 among the battery cells 100, and a fixing element 300 fixed to the battery casing 400 while extending through the dummy cell 200.

The battery system according to the exemplary embodiment of the present disclosure will be described in detail with reference to FIG. 1. A front member 11 and a rear member 12 are provided at front and rear end portions of the battery 10, respectively. Side members 13 are provided at left and right sides of the battery 10, respectively.

The side members 13 disposed at left and right sides are connected, at front and rear end portions thereof, to left and right end portions of the front member 11 and the rear member 12, respectively, and accordingly, outsides of the battery 10 are interconnected in a form of a quadrangular structure.

Furthermore, upper and lower portions of the battery 10 are covered by the battery casing 400 so that the accommodation space is formed at an inside of the battery 10.

A plurality of battery cells 100 and a dummy cell 200 are mounted in the accommodation space.

The battery cells 100 may have a polygonal shape, for example, a rectangular shape, and are mounted in the accommodation space while overlapping one another in the row direction and the column direction thereof.

Meanwhile, the dummy cell 200 is a polygonal cell, for example, a rectangular cell, formed of a material having higher stiffness than that of the battery cells 100 (for example, aluminum, steel, etc.). The dummy cell 200 is formed to include the same external shape as that of the battery cells 100, and accordingly, may be disposed to substitute for one battery cell 100.

Accordingly, when a position where fixing of the battery cells 100 to the battery casing 400 is required is set, no battery cell 100 is mounted at the set position, and in place, the dummy cell 200 is mounted at the set position.

Thereafter, the fixing element 300 extends through the mounted dummy cell 200 and is then fastened to the battery casing 400. Thus, mounting of the battery cells 100 to the battery casing 400 is achieved.

As described above, in accordance with the exemplary embodiment of the present disclosure, the battery cells 100 and the rigid dummy cell 200 are configured to take the form of modules having the same size, respectively, and the dummy cell 200 is mounted at a desired position in place of the battery cell 100 corresponding to the position. As the rigid dummy cell 200 is fastened to the battery casing 400, a desired mounting structure may be realized.

Accordingly, it may be possible to design a coupling structure between the battery 10 and a vehicle in which the battery 10 is mounted, in accordance with a structure of the vehicle. Thus, an enhancement in design freedom of the battery 10 may be achieved.

Furthermore, it may be possible to enhance a battery integration degree through removal of longitudinal members/lateral members disposed across a middle portion of the battery 10, increasing an all-electric range (AER). Furthermore, an enhancement in mounting coupling force may be achieved by the rigid dummy cell 200. Accordingly, collision/durability/noise, vibration and harshness (NVH) performance may be maintained and enhanced.

Furthermore, the fixing element 300 may extend through the dummy cell 200 in an upward-downward direction and may then be fixed to an upper plate 410 and a lower plate 420 of the battery casing 400.

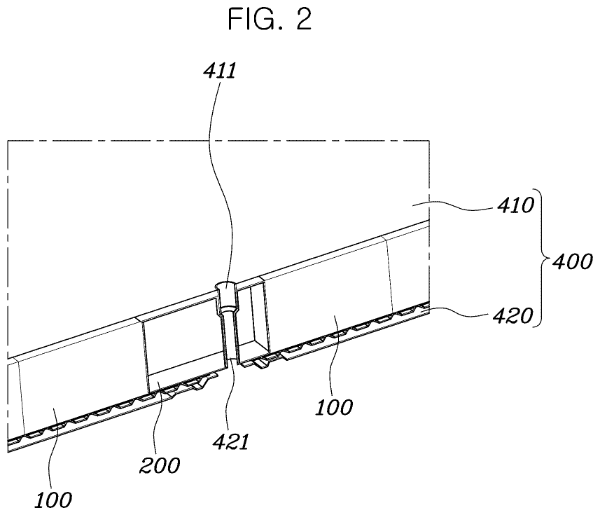

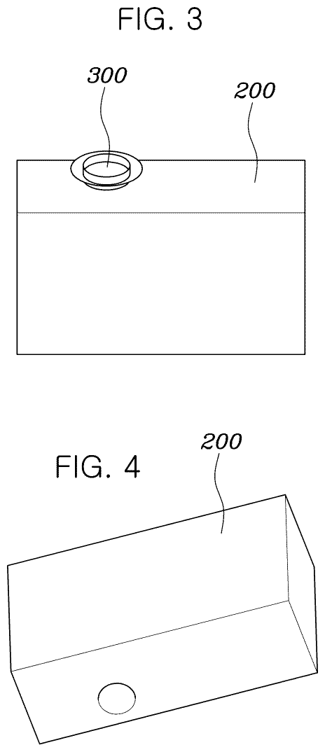

For example, as shown in FIG. 2, FIG. 3 and FIG. 4, the fixing element 300 may be a bolt. In the instant case, holes are formed at upper and lower end portions of the dummy cell 20, respectively so that upper and lower end portions of the bolt extend through the holes, respectively. Alternatively, a hole may extend through the dummy cell 200 in the upward-downward direction to have a pipe shape so that the bolt extends through the hole.

Furthermore, as the upper end portion of the bolt is fastened to the upper plate 410 provided at an upper portion of the battery 10, and the lower end portion of the bolt is fastened to the lower plate 420 provided at a lower portion of the battery 10, the dummy cell 200 may be fixed to the battery casing 400.

Furthermore, fastening holes 411 and 421 may be formed at the upper plate 410 and the lower plate 420, corresponding to the upper and lower end portions of the fixing element 300, respectively, and, accordingly, the fixing element 300 may be fastened to the fastening holes 411 and 421.

That is, once a position where the dummy cell 200 will be mounted is determined, the fastening holes 411 and 421 are formed at the upper plate 410 and the lower plate 420, corresponding to positions of the upper and lower end portions of the fixing element 300 extending through the dummy cell 200, respectively, and the fixing element 300 may be then fastened to the fastening holes 411 and 421 through bolting.

In an exemplary embodiment of the present disclosure the fastening hole 411 formed at the upper plate 410 may have a diameter larger than a diameter of the fastening hole 421 formed at the lower plate 420.

Accordingly, it may be possible to easily fasten the bolt in accordance with a structure of the battery-mounted vehicle only by varying positions of the fastening holes 411 and 421 formed at the upper plate 410 and the lower plate 420 in accordance with a position of the dummy cell 200.

Meanwhile, in accordance with the exemplary embodiment of the present disclosure, the battery cells 100 and the dummy cell 200 may be fixed to other battery cells 100 and another dummy cell 200 overlapping therewith.

That is, battery cells 100 and a dummy cell 200 disposed in a column direction of the battery 10 may be fixed to one another, and, accordingly, the cells disposed in each row may be connected to one another in a column direction thereof.

Furthermore, battery cells 100 and a dummy cell 200 disposed in a row direction of the battery 10 may be fixed to one another, and, accordingly, the cells disposed in each column may be connected to one another in a row direction thereof.

Hereinafter, a configuration in which the battery cells 100 and the dummy cell 200 are fixed to one another will be described in detail. The battery cells 100 disposed in the same row or column as that of the dummy cell 200 may be surface-bonded to one another at peripheral surfaces thereof by a bonding member 500.

The bonding member 500 may be a structural adhesive, a tape, or the like.

That is, battery cells 100 disposed in the same row or column as that of the dummy cell 200 and the dummy cell 200 are bonded to one another by the bonding member 500.

Accordingly, it may be possible to distribute a load passing through a member extending through the battery, such as a battery cross member, by the rigid dummy cell 200.

Furthermore, peripheral surfaces of each battery cell 100 and the dummy cell 200 may be surface-bonded to peripheral surfaces of another battery cell 100 and another dummy cell 200 surface-contacting with the former battery cell 100 and the former dummy cell 200 by the bonding member 500.

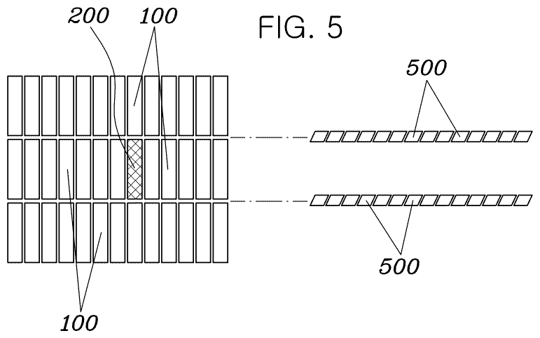

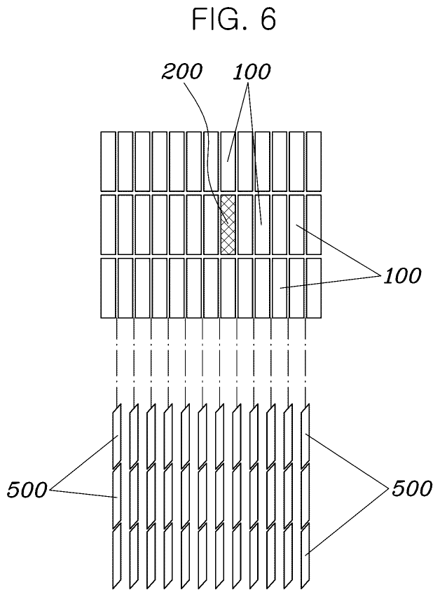

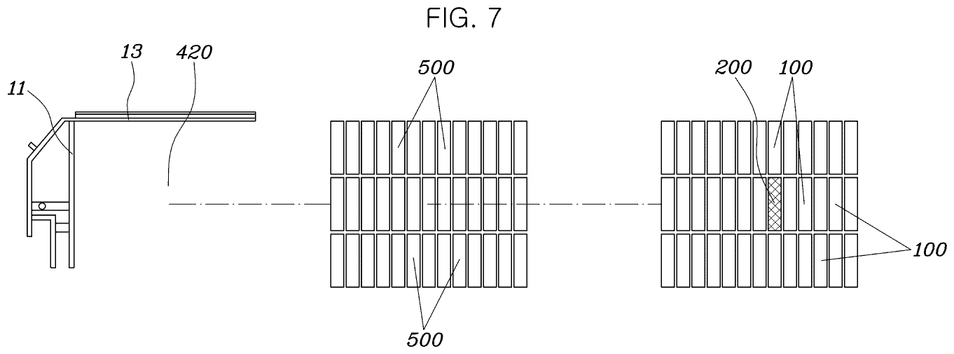

That is, as shown in FIG. 5, a left or right surface of one battery cell 100 and a left or right surface of one dummy cell 200 may be fixed to a right or left surface of another battery cell 100 or a right or left surface of another dummy cell 200 surface-contacting with the former battery cell 100 or the former dummy cell 200 in a column direction are fixed to each other by a structural adhesive, a tape, or the like. Accordingly, cells overlapping in each row may be surface-bonded together.

Furthermore, as shown in FIG. 6, a front or rear surface of one battery cell 100 and a front or rear surface of one dummy cell 200 may be fixed to a rear or front surface of another battery cell 100 or a rear or front surface of another dummy cell 200 surface-contacting with the former battery cell 100 or the former dummy cell 200 in a row direction are fixed to each other by a structural adhesive, a tape, or the like. Accordingly, cells overlapping in each column may be surface-bonded together.

Accordingly, as the cells are surface-bonded together, bonding force among the cells is enhanced. As a result, stiffness of the battery 10 is secured.

Furthermore, the battery cells 100 and the dummy cell 200 may be continuously fixed to one another in the row direction and the column direction, and accordingly, may be connected together in a form of a module.

That is, as shown in FIG. 5 and FIG. 6, the cells in the battery 10 may be coupled together in a form of a module by interconnecting, in the column direction, the cells overlapping one another in each row, and interconnecting, in the row direction, the cells overlapping one another in each column.

Furthermore, the battery cells 100 and the dummy cell 200 may be fixed to a bottom surface of the battery 10.

In detail, lower surfaces of the battery cells 100 and the dummy cell 200 may be surface-bonded to an upper surface of the lower plate 420 of the battery casing 400 surface-contacting with the lower surfaces by a bonding member 500.

That is, as shown in FIG. 7, the lower surfaces of the battery cells 100 and the dummy cell 200 may be fixed to the upper surface of the lower plate 420 surface-contacting with the lower surfaces by a structural adhesive, a tape, or the like, and, accordingly, the cells of the battery 10 may be surface-bonded to the lower plate 420.

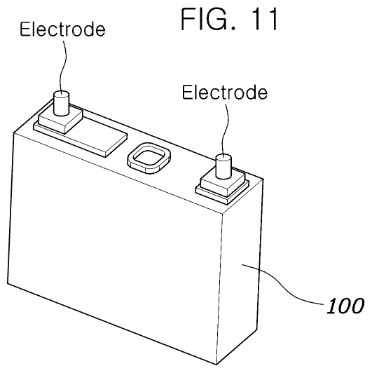

For reference, as shown in FIG. 11, upper surfaces of the battery cells 100 are not coupled to the upper plate 410 due to connection of electrodes and bus bars thereto.

Furthermore, members disposed at front, rear, left and right sides of the battery 10 are interconnected, forming an accommodation space. The battery cells and the dummy cell 200 facing the interconnected members disposed at the front, rear, left and right sides of the battery 10 may be fixed to the interconnected members.

In detail, internal surfaces of the interconnected members disposed at the front, rear, left and right sides of the battery 10 may be surface-bonded to peripheral surfaces of the battery cells 100 and the dummy cell 200 facing the interconnected members by a bonding member 500.

That is, as shown in FIG. 8, front surfaces of foremost ones of the battery cells 100 are fixed to a rear surface of the front member 11 surface-contacting with the front surfaces of the foremost battery cells 100 by a structural adhesive, a tape or the like, and rear surfaces of rearmost ones of the battery cells 100 are fixed to a front surface of the rear member 12 surface-contacting with the rear surfaces of the rearmost battery cells 100 by a structural adhesive, a tape or the like.

Accordingly, as the cells in the battery 10 are fixed to front, rear, and lower portions of the battery 10 in a surface-bonding manner, it may be possible to enhance bonding force of the cells and to secure stiffness of the battery 10 while omitting internal members.

Meanwhile, in accordance with an exemplary embodiment of the present disclosure, the dummy cell 200 may be mounted in plural in the battery 10, and a stay 600 or 700 may be connected between adjacent ones of the plurality of dummy cells 200, to enhance coupling stiffness among the plurality of dummy cells 200.

That is, the stay 600 or 700, which is a separate rigid member, may be connected between adjacent ones of the dummy cells 200, enhancing coupling stiffness among the dummy cells 200.

In detail, the dummy cells 200 are mounted under the condition that at least one battery cell 100 is disposed therebetween, and the stay 600 or 700 may be connected between the dummy cells 200 while extending across the battery cell 100 between the dummy cells 200.

Furthermore, the stay 600 or 700 may be connected to the dummy cells 200 under the dummy cells 200.

That is, when at least two dummy cells 200 are disposed at front and rear sides in a longitudinal direction of the battery 10, respectively, the stay 600 or 700 is fixed, at a front end portion thereof, to a lower portion of the front dummy cell 200 while being connected, at a rear end portion thereof, to a lower portion of the rear dummy cell 200, interconnecting the dummy cells 200.

Accordingly, coupling stiffness between the two dummy cells 200 and the battery cell 100 disposed therebetween may be enhanced.

Furthermore, when at least two dummy cells 200 are disposed at left and right sides along a lateral direction of the battery 10, respectively, the stay 600 or 700 is fixed, at a left end portion thereof, to a lower portion of the left dummy cell 200 while being connected, at a right end portion thereof, to a lower portion of the right dummy cell 200, interconnecting the dummy cells 200.

Accordingly, coupling stiffness between the two dummy cells 200 and the battery cell 100 disposed therebetween may be enhanced.

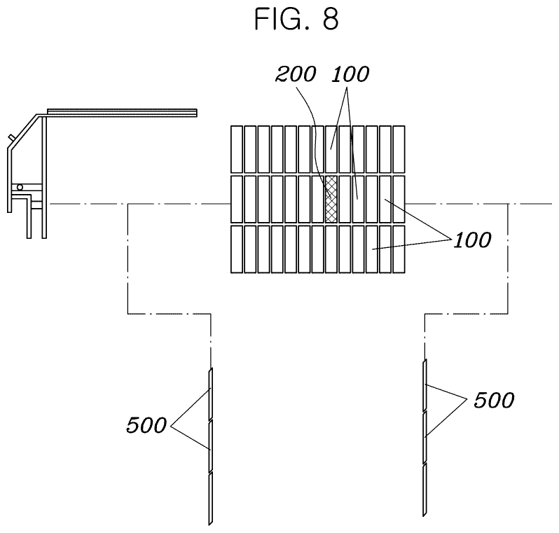

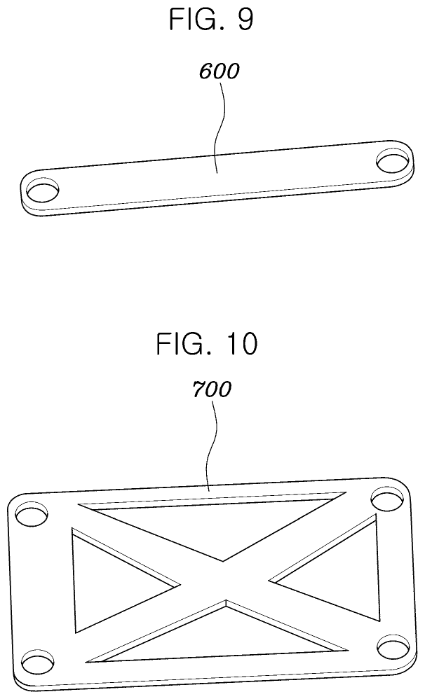

As various exemplary embodiments of the stay, as shown in FIG. 9, the stay designated by reference numeral “600” may be formed to have an “I” shape such that the stay 600 is connected among a plurality of dummy cells 200 mounted in a column direction.

In detail, when battery cells 100 and dummy cells 200 are bonded to one another only in a row direction by a bonding member 500 without being bonded to one another in a column direction, those including dummy cells 200 among columns of cells interconnected in the row direction function as row members.

In the instant case, opposite end portions of the stay 600 are connected to the dummy cells 200 disposed at left and right sides, respectively, and, accordingly, the stay 600 not only additionally enhances stiffness of the battery 10, but also distributes force in left and right directions when external force is input in the row direction.

As various exemplary embodiments of the stay, as shown in FIG. 9, the stay designated by reference numeral “600” may be formed to have an “I” shape so that the stay 600 is connected among a plurality of dummy cells 200 mounted in the row direction.

In detail, when battery cells 100 and dummy cells 200 are bonded to one another only in the column direction by a bonding member 500 without being bonded to one another in the row direction, those including dummy cells 200 among rows of cells interconnected in the column direction function as column members.

In the instant case, opposite end portions of the stay 600 are connected to the dummy cells 200 disposed at front and rear sides, respectively, and, accordingly, the stay 600 not only additionally enhances stiffness of the battery 10, but also distributes force in forward and rearward directions when external force is input in the column direction.

As various exemplary embodiments of the stay, as shown in FIG. 10, the stay designated by reference numeral “700” may be formed to have an “X” shape so that the stay 700 is connected among a plurality of dummy cells 200 mounted in the column direction and the row direction.

That is, as a scheme capable of maximizing stiffness of the battery 10, the stay 700 may be connected, at four corners thereof, to dummy cells 200 disposed in a form of a quadrangle, respectively, in a state in which battery cells 100 and the dummy cells 200 are not only interconnected in the column direction and the row direction, but also fixed to a lower plate 420 and front and rear members.

Accordingly, it may be possible to not only maximize stiffness of the battery 10, but also to optimally distribute external force input from outside thereof.

As apparent from the above description, in accordance with the present disclosure, a battery mounting structure is realized by mounting a rigid dummy cell 200 at a desired position in place of a battery cell 100 disposed at the position, and fastening the dummy cell 200 to a battery casing 400. Accordingly, it may be possible to enhance freedom of design of the battery 10 by designing a coupling structure between the battery 10 and a vehicle, in which the battery 10 is mounted, in accordance with a structure of the vehicle.

Furthermore, it may be possible to increase an all-electric range through enhancement in battery integration degree. Furthermore, an enhancement in mounting coupling force may be achieved by the rigid dummy cell 200. Accordingly, NVH performance may be maintained and enhanced.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A battery system comprising:
battery cells mounted in an accommodation space formed in a battery casing for a battery so that the battery cells overlap one another in a row direction and a column direction of the battery casing;
a dummy cell having a predetermined stiffness or more than the predetermined stiffness and mounted in the accommodation space to substitute for a battery cell disposed at a position required for fixing to the battery casing among the battery cells; and
a fixing element fixed to the battery casing while extending through the dummy cell.

2. The battery system of claim 1, wherein the fixing element extends through the dummy cell in an upward-downward direction, and is fastened to upper and lower plates of the battery casing.

3. The battery system of claim 2, wherein fastening holes are formed at the upper plate and the lower plate, corresponding to upper and lower end portions of the fixing element, respectively, and the fixing element is fastened to the fastening holes through the fastening holes.

4. The battery system of claim 3, wherein the fastening hole formed at the upper plate has a diameter larger than a diameter of the fastening hole formed at the lower plate.

5. The battery system of claim 1, wherein the battery cells and the dummy cell are fixed to other battery cells and another dummy cell overlapping therewith.

6. The battery system of claim 1, wherein the dummy cell and the battery cells disposed in the same row or column as the dummy cell are surface-bonded to one another at peripheral surfaces thereof by a bonding member.

7. The battery system of claim 5, wherein the battery cells and the dummy cell are continuously fixed to one another in the row direction and the column direction, to be connected together in a form of a module.

8. The battery system of claim 1, wherein the battery cells and the dummy cell are fixed to a bottom surface of the battery.

9. The battery system of claim 1, wherein lower surfaces of the battery cells and the dummy cell are surface-bonded to an upper surface of a lower plate of the battery casing surface-contacting with the lower surfaces by a bonding member.

10. The battery system of claim 1,
wherein the accommodation space is formed through interconnection of front, rear, left and right members disposed at front, rear, left and right sides of the battery, and
wherein cells facing the interconnected front, rear left and right members among the battery cells and the dummy cell are fixed to the interconnected front, rear left and right members.

11. The battery system of claim 1, wherein internal surfaces of front, rear, left and right members respectively connected to front, rear, left and right sides of the battery are surface-bonded to peripheral surfaces of the battery cells and the dummy cell facing the internal surfaces by a bonding member.

12. The battery system of claim 1,
wherein the dummy cell is mounted in plural in the battery; and
wherein a stay is connected among the plurality of dummy cells to enhance coupling stiffness among the plurality of dummy cells.

13. The battery system of claim 12, wherein the plurality of dummy cells are mounted while at least one battery cell is disposed therebetween, and the stay is connected between the plurality of dummy cells while extending across the at least one battery cell between the plurality of dummy cells.

14. The battery system of claim 12, wherein the stay is connected to the plurality of dummy cells under the plurality of dummy cells.

15. The battery system of claim 12, wherein the stay is formed to have an “I” shape, and is connected among the plurality of dummy cells mounted in the column direction.

16. The battery system of claim 12, wherein the stay is formed to include an “I” shape, and is connected among the plurality of dummy cells mounted in the row direction.

17. The battery system of claim 12, wherein the stay is formed to have an “X” shape, and is connected among the plurality of dummy cells mounted in the column direction and the row direction.
